(19) United States
(12) Patent Application Publication
(10) Pub. No.: US 2010/0117316 A1
(43) Pub. Date: May 13, 2010

(54) SCOOTER WITH INCLINED CASTER

(76) Inventors: Jasun Weiner, Laguna Beach, CA (US); Martin Dalgaard, Topanga, CA (US)

Correspondence Address: CHRISTIE, PARKER & HALE, LLP, PO BOX 7068, PASADENA, CA, 91109-7068, US

(21) Appl. No.: 12/534,092

(22) Filed: Jul. 31, 2009

Related U.S. Application Data
(60) Provisional application No. 61/199,308, filed on Nov. 13, 2008.

(51) Int. Cl. B62M 1/12

(52) U.S. Cl. 280/87.042

(57) ABSTRACT

A scooter includes a platform with a front end, a rear end, a bottom, and a longitudinal axis parallel to the ground and extending through the front end and the rear end of the platform. The front end of the platform includes a front foot portion and the rear end includes a rear foot portion. A post is connected to the front end of the platform and extends generally upward from the front end of the platform. A front wheel is connected to the post such that at least a portion of the front wheel extends below the bottom of the platform. An inclined caster is connected to the rear end of the platform with at least a portion of the inclined caster extending below the bottom of the platform. The inclined caster configured so that the scooter is capable of being propelled forward generally along the longitudinal axis by the application of a force to the rear foot portion, the force being applied substantially perpendicular to the longitudinal axis.

### CROSS-REFERENCE TO RELATED APPLICATION(S)

This application claims priority to and the benefit of U.S. Provisional Patent Application Ser. No. 61/199,308, filed on Nov. 13, 2008, the entire contents of which are incorporated herein by reference.

### BACKGROUND OF THE INVENTION

Scooters, consisting of a running board with wheels on the bottom and handlebars connected to one or more of the wheels have been popular devices. When riding an unpowered scooter, the rider typically propels themselves by pushing off the ground with one foot while having the other foot on the running board of the scooter. Similarly, traditional skateboards are propelled in a similar manner.

More recently, variations on traditional skateboards have incorporated twistable foot boards and inclined casters rather than traditional skateboard trucks. An example of this type of board is described in U.S. Pat. No. 7,195,259 to Gang, which is incorporated by reference as if set forth in full herein. A rider of such a board can produce forward movement without pushing off the ground by alternatively twisting either or both of the foot boards.

Previous efforts have been made to use casters with scooters and/or to develop scooters that can be propelled without the rider having to push off the ground. However, these efforts have been unsatisfactory for a variety of reasons.

### SUMMARY OF THE INVENTION

A scooter includes a platform with a front end, a rear end, a bottom, and a longitudinal axis parallel to the ground and extending through the front end and the rear end of the platform. The front end of the platform includes a front foot portion and the rear end includes a rear foot portion. A post is connected to the front end of the platform and extends generally upward from the front end of the platform. A front wheel is connected to the post such that at least a portion of the front wheel extends below the bottom of the platform. An inclined caster is connected to the rear end of the platform with at least a portion of the inclined caster extending below the bottom of the platform. The inclined caster configured so that the scooter is capable of being propelled forward generally along the longitudinal axis by the application of a force to the rear foot portion, the force being applied substantially perpendicular to the longitudinal axis.

### BRIEF DESCRIPTION OF THE DRAWINGS

FIG. 1 shows a perspective view of a scooter with an inclined caster according to an embodiment of the invention.

FIG. 2 shows a side elevation view of a scooter with an inclined caster according to an embodiment of the invention.

FIG. 3 shows a top view of a scooter with an inclined caster according to an embodiment of the invention.

FIG. 4 shows a detailed side view of an inclined caster according to an embodiment of the invention.

FIG. 5 is a three-dimensional graph showing the affects of board tile and caster inclination on wheel turn of an inclined caster according to an embodiment of the invention.

FIG. 6 shows a detailed side view of an inclined caster in various states of rotation according to an embodiment of the invention.

FIG. 7 shows a force diagram of the application of sideways force to an inclined caster according to an embodiment of the invention.

### DETAILED DESCRIPTION OF THE INVENTION

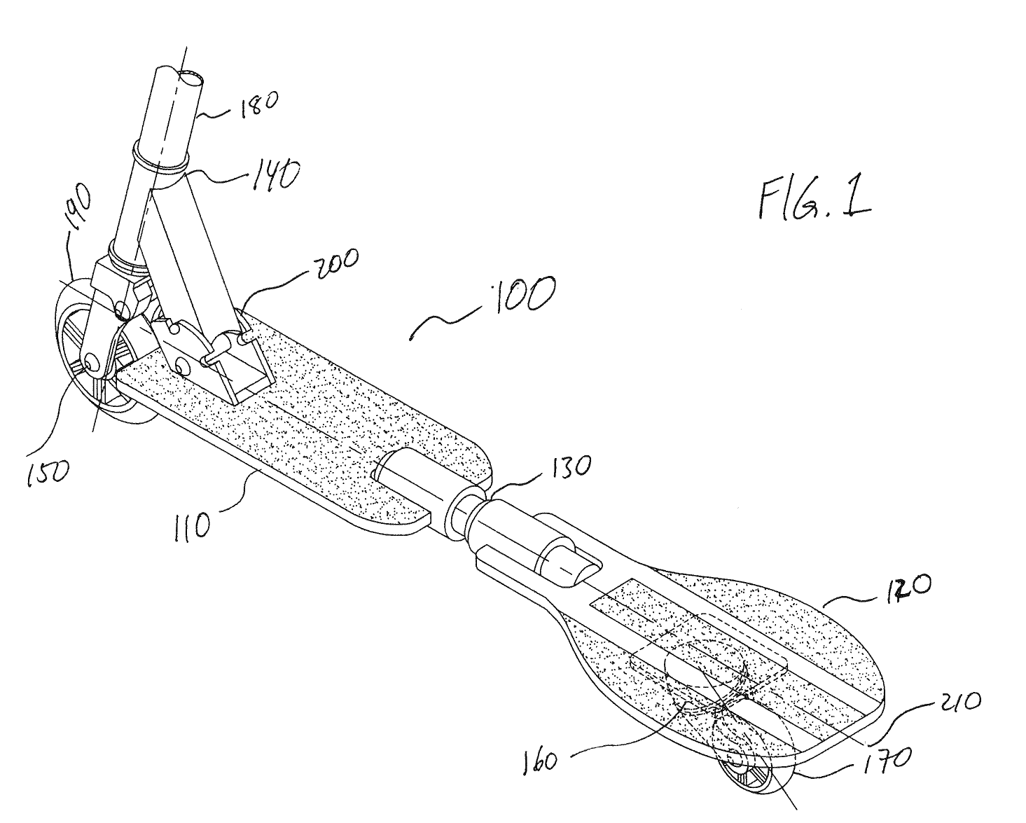

An embodiment of the invention is shown in FIG. 1. A scooter 100 includes a front foot board 110 and a rear foot board 120, connected by a torsion spring 130. When the torsion spring is at rest, the front foot board and the rear foot board lie in the same or substantially parallel planes. The torsion spring allows the foot boards to be twisted relative to each other generally along longitudinal axis 210 with the application of force. In most embodiments, the torsion spring supplies counteracting force to move the foot boards toward their rest position when the application of force to twist the boards ceases or lessens. In some embodiments, the torsion spring includes a latch that prevents the foot boards from twisting. In some embodiments, the torsion spring includes engageable limiters that prevent the torsion spring from allowing the foot boards to be twisted more than a predetermined amount. In some embodiments, the torsion spring includes adjustable tension so that the force required to twist the foot boards can be increased or decreased. In other embodiments, the torsion spring is a torsion bar in which the material making up the torsion bar itself is twisted when the boards are twisted and the twisting of the bar itself supplies the torsion effect. In many of the torsion bar embodiments, materials other than metal, such as certain plastics, are used to form the torsion bar because of the reduced amount of force required to twist the material compared with most metals. In some of these embodiments, the torsion bar is formed integrally with one or both of the foot boards such that, in some cases, the two foot boards and the torsion bar are a single piece of material.

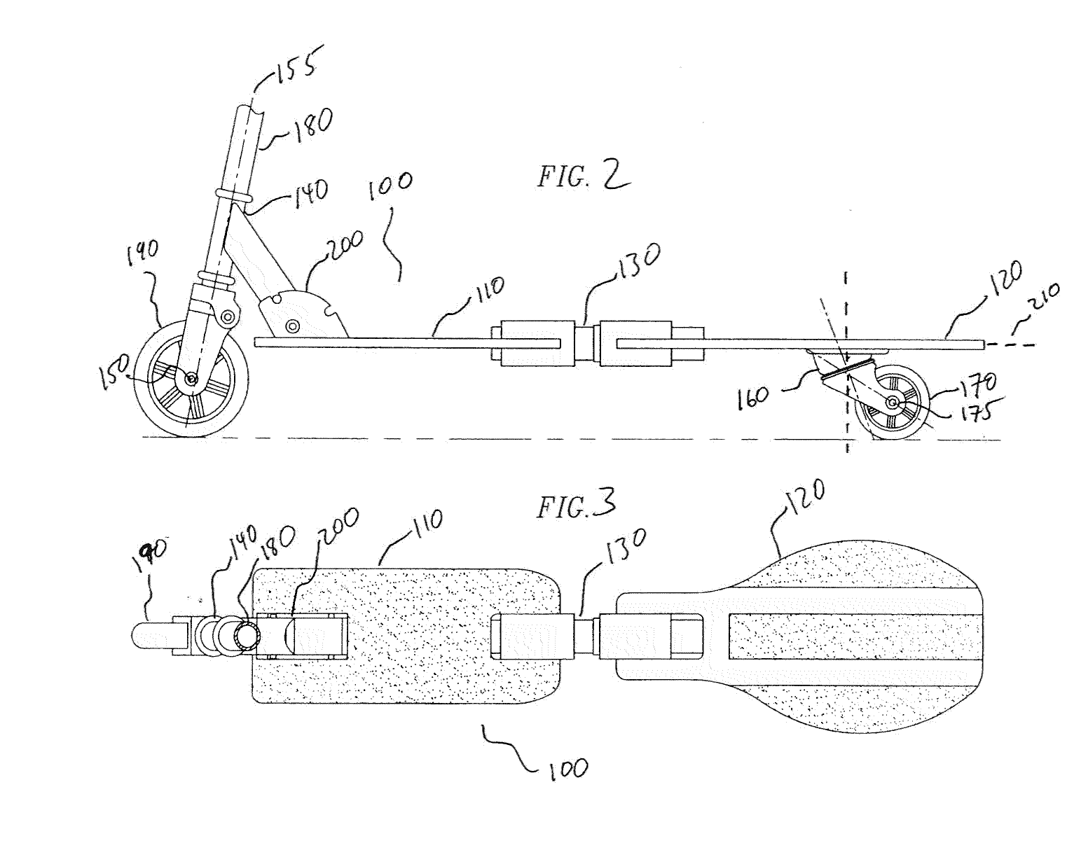

The front of the front foot board is connected to a head tube 140 that supports the handlebar post 180. Handlebars (not shown) are located at the top of the handlebar post. In some embodiments, the head tube (and thus the handlebars and post) are connected to the front foot board with hinge 200 that allows folding of the scooter for more convenient storing or transport. The handlebar post is connected to the front wheel 190 through front axle 150. As shown in FIGS. 1 and 2, the handlebar post has an axis 155 running its length around which the handlebar post rotates. Rotating the handlebar post results in the front wheel 190 turning sideways, providing a steering mechanism for the rider. In some embodiments, the front axle is forward of the handlebar post axis 155, as shown in FIGS. 1 and 2. In other embodiments, the front axle is in line with or behind the handlebar post axis. The location of the front axle relative to the handlebar post axis can affect handling and stability and may have different effects on handling and/or stability depending on the speed of the scooter.

The rear foot board is supported by inclined caster 160 that holds rear wheel 170 with rear axle 175. The inclined caster rotates around caster axis 165. In most embodiments, the caster axis is in the same vertical plane as the longitudinal axis 210. The caster axis forms an acute angle, however, with both vertical axis 185 and the longitudinal axis 210. Additionally, in preferred embodiments, the rear axle is offset from the caster axis. When the rear foot board is twisted so that it is not parallel to the ground, the inclined caster rotates and the rear wheel moves in the opposite direction of the side of the rear foot board that is nearer to the ground. This causes the rear of the scooter to move diagonally to the side of the rear foot board that is nearer to the ground. In this way, steering input can be provided by tilting the rear foot board in addition to using the handlebars and turning the front wheel.

In some embodiments, the rear caster, the front wheel, or both include centering mechanisms, such as springs, to apply a force to the rear caster and/or front wheel that tends to return the rear caster and/or front wheel to be in line with the longitudinal axis 210 or some other at rest position. In some embodiments, either the rear caster, the front wheel, or both include locking mechanisms that, when engaged, prevent the caster or wheel from turning or limit the degree to which they can be rotated.

In some embodiments, there is more than one rear wheel. In some of these embodiments, the multiple rear wheels are arranged in a longitudinal line, in others they are along a line perpendicular to the longitudinal line, and in still others they are not aligned along either the longitudinal line or the line perpendicular to it. In yet other embodiments the relative placement of the rear wheels are a combination of one or more of along the longitudinal line, along the line perpendicular to it, or not aligned with either. In some embodiments with more than one rear wheel, one or more of the rear wheels is not mounted on an inclined caster, but rather is mounted on an upright caster or in a fixed position.

In some embodiments, there is more than one front wheel. In some of these embodiments, the multiple front wheels are arranged in a longitudinal line, in others they are along a line perpendicular to the longitudinal line, and in still others they are not aligned along either the longitudinal line or the line perpendicular to it. In yet other embodiments the relative placement of the front wheels are a combination of one or more of along the longitudinal line, along the line perpendicular to it, or not aligned with either. In some embodiments with more than one front wheel, one or more of the front wheels is not mounted in a fixed relationship to the handlebar, but rather is mounted on an inclined caster, an upright caster, or in a fixed position relative to the front board.

In some embodiments, one or more inclined casters used for front or rear wheels are inclined toward the front of the scooter rather than inclined toward the rear of the scooter.

In some embodiments, the wheel connected to the handlebars is mounted on the rear board rather than to the front board. In most of these embodiments, the handlebar is mounted at the rear of the rear board. Also in most of these embodiments, the wheel connected to the handlebars is the only rear wheel and the front wheel is mounted on an inclined caster.

In some embodiments, one or more wheels are connected to the torsion spring.

In preferred embodiments, the scooter is configured so that propulsion can be provided to the scooter by alternatively twisting the rear foot board first one way and then the opposite way. However, the particular configurations of different components of the scooter affect the ability of a rider to achieve such propulsion or affect the degree to which the propulsion is achievable. The particular configurations also affect the handling of the scooter at various speeds. Among the configuration variables that are believed to affect propulsion and handling are the wheelbase (horizontal distance between the front and rear axles), size of the front and/or rear wheels, height of the front foot board, height of the rear foot board, angle of the handlebar post axis, angle of the caster axis, offset of the front axle from the handlebar post axis, offset of the rear axle from the caster axis, size and relative size and positioning of the front and rear foot boards, and position and strength of the torsion spring. Various combinations of these and other configuration variables that achieve sufficient propulsion and handling are all within the scope of the various embodiments of the invention.

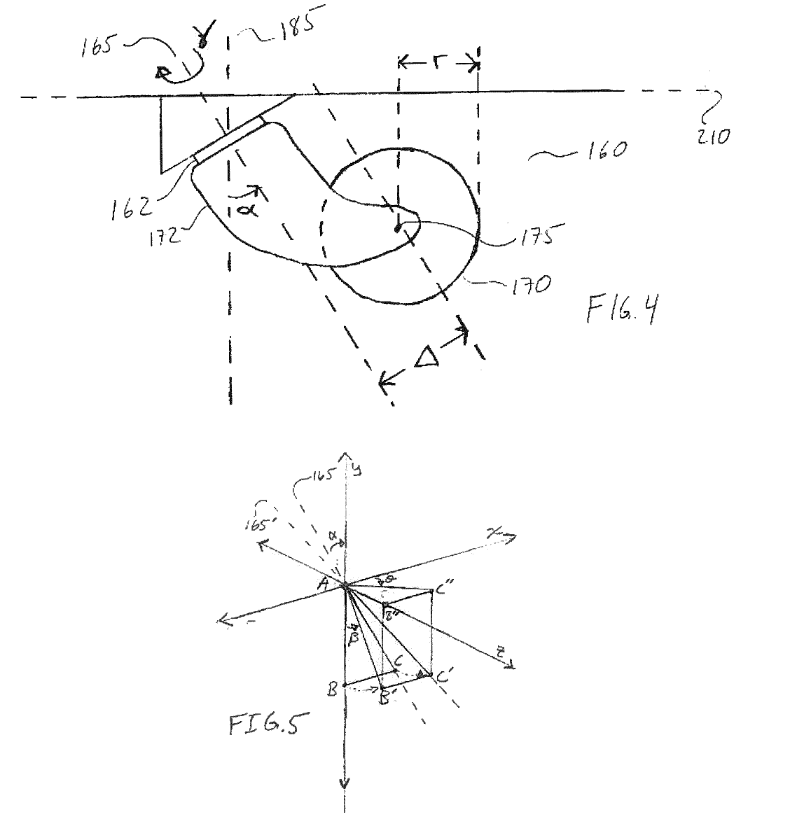

As discussed above, in operation, when the rear foot board is tilted around the longitudinal axis of the rear foot board, the wheel of the inclined caster will turn relative to the longitudinal axis of the rear foot board, in the opposite direction of the tilt. Further, the degree to which a wheel mounted on an inclined caster turns relative to the longitudinal axis of the rear foot board is not in a linear relationship to the degree to which the board is tilted. A more detailed view of an inclined caster is shown in FIG. 4. More specifically, incline caster 160 is shown that has a bearing 162, with its axis aligned with inclined axis 165. Inclined axis 165 forms an angle alpha (α) with a vertical axis 185 that is perpendicular to the longitudinal axis 210 of the board on which the inclined caster is mounted. In many embodiments, inclined axis 165 also lies on the plane defined by vertical axis 185 and the longitudinal axis 210. A bracket 172 is connected to the bearing so that rotates around inclined axis 165 such that axle 175 also rotates around axis 165, at a fixed distance, delta (Δ). Wheel 170 is mounted on axle 175 and has a radius of r. The amount rotation of the caster bracket around inclined axis 165 is defined as angle gamma (γ), with γ=0 when the wheel is in the position shown in FIG. 4.

FIG. 5 shows the affect of tilting the board around longitudinal axis 210 on the inclined axis 165 and thus wheel 170. In FIG. 5, the longitudinal axis 210 lies along the x axis, vertical axis 185 lies along the y axis, and inclined axis 165 is shown, forming angle α with the vertical axis. Thus, point A corresponds to the center of the caster bearing 162. A̅B̅ corresponds to the segment of vertical axis 185 from its intersections with inclined axis 165 and the ground, at point B. A̅C̅ corresponds to the segment of inclined axis 165 from its intersections with vertical line 185 to the ground, at point C, thus forming ∠BAC=α. Tilting the board by angle β results in center of the caster bearing being rotated around the ground axis by angle β with point B moving to point B′ and the inclined axis moving to the position shown by 165′ and A̅C̅ moving to A̅C̅′̅. Projecting A̅C̅′̅ onto the x-z plane yields A̅C̅″̅, which corresponds to the direction of the wheel 170, when the board is tilted around the longitudinal axis by angle β In FIG. 5, ω represents the angle of wheel turn, and equals ∠AB″C″.

From FIG. 5, it is seen that

$$tan ω = \frac{\overline{{AB}^{″}}}{\overline{{B}^{″} {C}^{″}}} .$$

To find A̅B̅″̅, see that A̅B̅″̅= A̅B̅′̅ sin β and A̅B̅′̅= A̅C̅ cos α, so A̅B̅″̅= A̅C̅ sin β cos α. To find B̅″̅C̅″̅, see that B̅″̅C̅″̅= B̅′̅C̅′̅= B̅C̅= A̅C̅ sin α. Thus,

$$tan ω = \frac{\overline{A C} sin β cos α}{\overline{A C} sin α} = \frac{sin β}{tan α} and ω = arctan ( \frac{sin β}{tan α} ) .$$

According to these formulas, absent other forces acting on the board and the wheels, when the caster incline 165 is less than 45° (α<45°), the degree of wheel turn will be more than the degree of board tilted, for at least some angles of board tilt. Indeed, when the board begins to be tilted, each degree of tilt results in more than one degree of wheel turn (ω), up to a board tilt of about 15-30°, depending on the amount caster incline (α). However, past a board tilt of about 15-30°, again depending on the amount caster incline (α), each degree of board tilt results in less than one degree of wheel turn and the amount of wheel turn produced by board tilt continues to decrease the more the board tilt is beyond about 15-30°. Beyond board tilt angles of about 50-55°, the amount of wheel turn produced by additional board tilt becomes negligible.

The less the inclined axis 165 is inclined (the smaller α is), the more pronounce this effect is. Thus, with a caster inclined at 25°, the wheel will turn about 47° when the board it tilted 30°. However, with a caster inclined at 30°, the wheel will only turn about 41° when the board is tilted that same 30°.

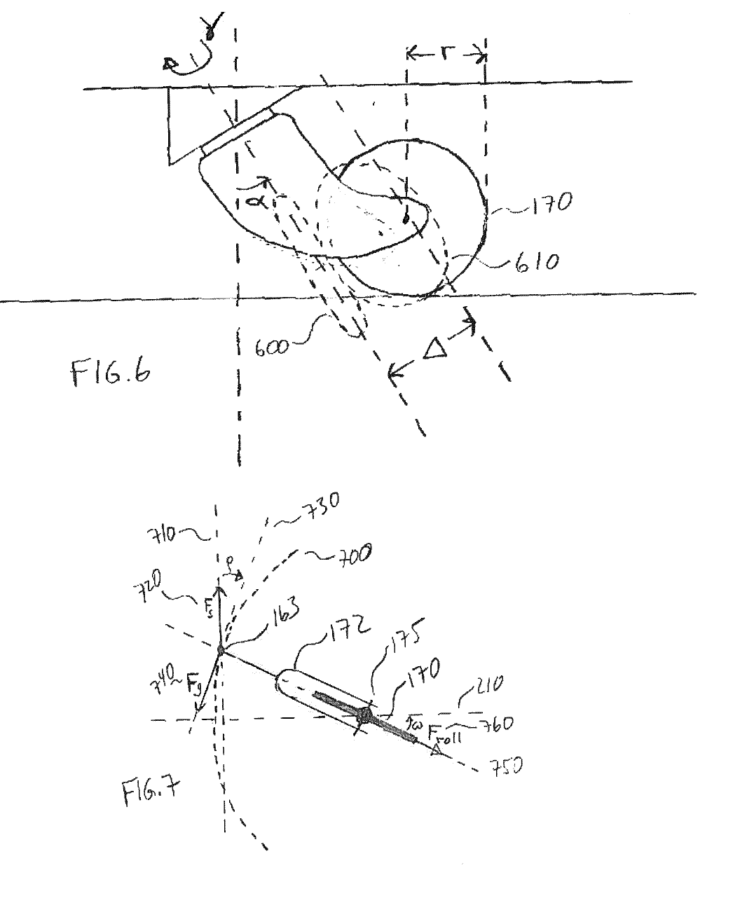

Turning to FIG. 6, the wheel 170 shown in solid lines is shown in a position where it would be when the board is resting on the ground, with no longitudinal tilt (β=0). More particularly, the wheel lies in the plane defined by the vertical axis 185 and the longitudinal axis 210. Ghosted wheel 600 shows the position of wheel 170 when the caster is rotated 90° (γ=90°), while ghosted wheel 610 shows the position of the wheel 170 when the caster is rotated 45° (γ=45°). As can be seen, the distance between the bottom of wheel and the board increases as the caster is rotated (i.e., γ increases toward 180°). This, when the board is placed on the ground, gravitational force pulls the board downward, while the ground exerts an equal and opposite force on the bottom of the wheel. As very little friction restricts rotation of caster bearing 162, the force exerted on the wheel by the ground will rotate the caster around the inclined axis 165 until the wheel is at its least distance from the board, which is when the wheel is in the position shown in solid lines (γ=0).

It can be appreciated that sideways force applied to the top of the inclined caster would tend to cause the inclined caster to rotate. However, as shown in FIG. 6, when the wheel 170 of the inclined caster 160 is resting on the ground, rotating the inclined caster causes the board (and thus the rider as well) to be raised off of the ground slightly, and this raising of the board will be resisted by gravity. Also, from FIG. 6, it can be seen that the more the inclined caster is inclined (the greater α is), the more the board is raised by the same amount of caster rotation.

Thus, in addition to the tilt of the board, sideways force applied to the board above an inclined caster also generally causes the inclined caster to rotate and the wheel to turn. When a scooter according to a preferred embodiment is at rest, with a rider standing on it, as discussed above, the caster wheel is aligned with the longitudinal axis of the scooter. Accordingly, movement of the wheel perpendicular to the longitudinal axis of the scooter (i.e., sideways) is resisted by the friction between the bottom of the wheel and the ground. On most surfaces and with typical amounts of sideways force applied, the resistance provided by the friction prevents any significant sideways movement of the wheel.

When a sideways force is applied to the board above an inclined caster, this force is applied relative to the caster at the point where the caster connects to the board. Thus, when the board is moved sideways, the bottom of the wheel stays stationary, resulting in the caster rotating and the wheel turning in the opposite direction of the sideways force.

The effects of sideways force being applied to a board with an inclined caster are shown in FIG. 7.

FIG. 7 shows a force diagram for an inclined caster that has already undergone some sideways force that has caused it to turn. FIG. 7 shows the wheel 170, caster bracket 172, and axle 175 in a schematic view, along with the center 163 of bearing 162 (not shown). The path travelled by the bearing center 163 is shown in FIG. 7 as the dashed path 700. It is noted that the path 700 of the bearing center 163 depends on the inclination a of the inclined axis 165 (not shown). The inclination path shown in FIG. 7 is an approximation of the bearing center path when the caster is inclined by 25°. The sideways force is represented by force vector \vec{Fₛ} 720, that is aligned with sideways axis 710, which is perpendicular to both longitudinal axis 210 and vertical axis 185 (not shown). Line 730 represents the line tangent to bearing cast path 700 at the point of the caster bearing center 163. The angle formed between sideways axis 710 and tangent line 730 is shown as ρ. The force of gravity opposing the raising of the board applies as force vector \vec{F_{g}} 730. The raising of the board by rotating the caster is analogous to pushing a weight up a hill along the curved path taken by the caster bearing center. Thus, vector \vec{F_{g}} lies along line 730 that is tangent to the bearing center path 700. Recalling FIG. 6, the height increase due to the first 45° of caster rotation is quite small compared to the height increase due to the second 45° of caster rotation. Accordingly, it is expected that \vec{F_{g}} is relatively small when the caster has not been rotated at all and gradually increases as the amount of caster rotation increases.

Wheel 170 lies along rolling path 750. As discussed above, the amount of wheel turn is designated ω and is shown in FIG. as the angle between the rolling path 750 and the longitudinal axis 210. Accordingly, the angle between rolling path 750 and sideways axis 710 is 90°−ω. The force vector representing the force applied to roll the wheel 170 is shown as \vec{Fᵣₒₗₗ} 760,

According to a traditional force diagram analysis, using the longitudinal axis 210 as the x axis and the sideways axis 710 as the y axis, force vector Fₛ is applied completely along the y axis. Force vector \vec{F_{g}} is divided into \vec{F_{gr}}=\vec{F_{g}} cos ρ and \vec{F_{gx}}=\vec{F_{g}} sin ρ. Force vector \vec{Fᵣₒₗₗ} 760 is divided into \vec{F_{roll y}}=\vec{Fᵣₒₗₗ} cos(90°−ω)=\vec{Fᵣₒₗₗ} sin ω and \vec{F_{roll x}}=\vec{Fᵣₒₗₗ} sin(90°−ω)=\vec{Fᵣₒₗₗ} cos ω. Equating opposite forces along the y axis, \vec{Fₛ}=\vec{F_{gy}}+\vec{F_{roll y}}=\vec{F_{g}} cos ρ +\vec{Fᵣₒₗₗ} sin ω. Further, equating opposite forces along the x axis, \vec{F_{gx}}=\vec{F_{roll x}} [symbol] \vec{F_{g}} sin ρ=\vec{Fᵣₒₗₗ cos ω.}

From FIG. 7 and the equations above, it is seen that when a sideways force is applied to the board, and thus to the top of the caster, this force is split between counteracting gravity (\vec{F_{g}}) and propelling the board in the direction of the wheel (\vec{Fᵣₒₗₗ}). When the only a small amount of sideways force is applied, almost all of this force is applied to gravity (\vec{F_{g}}) as these two forces are nearly opposite. The more sideways force is applied, though, the more this force causes the wheel to turn, resulting in the wheel force vector being more opposite to the sideways force and thus, a larger portion of the sideways force being split to propelling the board in the direction of the wheel (\vec{Fᵣₒₗₗ}) rather than counteracting gravity (\vec{F_{g}}).

The amount that the inclined caster is inclined affects how the sideways force is split between counteracting gravity (\vec{F_{g}}) and propelling the board in the direction of the wheel (\vec{Fᵣₒₗₗ}). As discussed above, the more the caster is inclined, the higher the board is raised when the caster is rotated that same amount. In other words, the more the caster is inclined, the higher the gravitational force (\vec{F_{g}}) will be. Thus, when the sideways force is split between counteracting gravity (\vec{F_{g}}) and propelling the board in the direction of the wheel (\vec{Fᵣₒₗₗ}), more of the force has to be used to counteract gravity and less is available to propel the board when the caster incline is increased. Further, as the same amount of sideways force will result in less wheel turn when the caster inclination is increased, the wheel force vector will be less opposite to the sideways force, and thus receive a smaller portion of the split of the sideways force.

Increased caster inclination, though, has its advantages as well. For example, other things being equal, increasing the caster inclination lowers the center of gravity of the board, increasing stability. It can also a board easier to ride because the same amounts of board tilt, particularly caused by a rider trying to keep their balance, result in less unintended and unexpected wheel turn.

In some embodiments, instead of an inclined caster, a non-inclined caster, in other words, a caster with a vertical rotational axis, is used. In contrast with an inclined caster, the distance between the bottom of the wheel of a non-inclined caster and the board is constant when as the caster rotates around its axis. Thus, when the board is placed on the ground, rotating the wheel of the non-inclined caster does not result in the board being raised relative to the ground and thus does not cause any changes to the gravitational forces being applied to the wheel or non-inclined caster. Accordingly, when sideways force is applied to the top of the non-inclined caster, there are only minor frictional forces (e.g., the friction of the caster bearing) that resist the turning of the wheel until the wheel is turned directly away from the sideways force. Once the wheel is turned in the direction of the sideways force, though, all of the sideways force is applied in the sideways direction of the wheel and not into forward propulsion of the scooter. However, if a biasing device, such as a spring, is used to resist the turning of the wheel of the non-inclined caster from being directed along the longitudinal axis, the force applied by the biasing device has a similar effect to the gravitational force generated by the inclined caster described above, and can result in conversion of sideways force to forward propulsion as described above regarding inclined casters. Any biasing device that resists the turning of the wheel or even stops the turning of the wheel past a certain extent of turning from being aligned with the longitudinal axis when a sideways force is applied may be used to enable the scooter to convert sideways force into forward propulsion. Thus, a biasing device could be implemented as a ramp or cam that causes the distance between the bottom of the non-inclined caster wheel and the board to increase when the non-inclined caster wheel is turned (mimicking the effect of an inclined caster wheel). Other examples of biasing devices include, but are not limited to, torsion bars, torsion springs, constant force springs, and flat springs. In some embodiments, a combination of an inclined caster and a biasing device are used to resist the turning of the wheel from being aligned with the longitudinal axis when a sideways force is applied may be used to enable the scooter to convert sideways force into forward propulsion.

In operation, though, the effects of sideways force are particularly important in the differences between caster boards with inclined casters at both the front and rear of the board and a scooter with a single inclined caster in the rear. One way for a rider to generate sideways force is to twist their lower body. When a rider twists their lower body, they do not exert any net horizontal forces on their body. However, they generate two approximately equal either rotational forces at their feet. These two rotational forces are either both clockwise or both counterclockwise. However, when the feet are positioned above the two casters, these rotational forces turn into sideways forces relative to the longitudinal axis and they also become opposite in direction, namely, one is directed to one side of the longitudinal axis while the other is directed to thee other side of the longitudinal axis. Thus, two approximately equal sideways forces are applied to two different inclined casters and each inclined caster converts the sideways force into a combination of caster rotation and rolling force as described above.

This same twisting action made on a single inline caster scooter, though, has a somewhat different result. The forces being applied at the front and rear ends of the scooter are the same as those applied at the front and rear ends of a two inline caster board, only the force applied at the rear end of the scooter is converted into rolling force. The force at the front of the scooter, unless the wheel happens to be turned about 45° or more in the same direction as the twisting force, will simply be resisted by the friction that prevents the front wheel from sliding (not rolling) sideways. Accordingly, all other things being equal (e.g., caster incline angle, wheel base, etc.), the same twisting force applied by the rider of a single inclined caster scooter will produce only about half of the rolling force that is produced by an inline two incline caster board. Accordingly, greater conversion of sideways force on the single inclined caster of a caster scooter compared to an inline two incline caster board may be needed in order to be able to propel the caster scooter with sideways force applied to the scooter.

In one preferred embodiment, the angle between the caster axis and the vertical axis (α) is 25°, the offset between rear axle and the caster axis is approximately one and nine-sixteenth inches, the offset between the front axle and the handlebar post axis is approximately one-half inch, the wheelbase is approximately twenty-seven inches, and the top of the front and rear foot boards are below the top of the torsion spring.

What is claimed is:

1. A scooter comprising:
a platform having a front end, a rear end, a bottom, and a longitudinal axis parallel to the ground and extending through the front end and the rear end of the platform, the front end comprising a front foot portion and the rear end comprising a rear foot portion;
a post connected to the front end of the platform and extending generally upward from the front end of the platform;
a front wheel connected to the post such that at least a portion of the front wheel extends below the bottom of the platform; and
an inclined caster connected to the rear end of the platform with at least a portion of the inclined caster extending below the bottom of the platform, the inclined caster configured so that the scooter is capable of being propelled forward generally along the longitudinal axis by the application of a force to the rear foot portion, the force being applied substantially perpendicular to the longitudinal axis.

2. The scooter of claim 1 wherein the front foot portion comprises a front foot board and the rear foot portion comprises a rear foot board.

3. The scooter of claim 2 wherein the front foot board and the rear foot board are connected such that the rear foot board is twistable relative to front foot board, generally around the longitudinal axis.

4. The scooter of claim 2 wherein the front foot board and the rear foot board are connected such that the front foot board is twistable relative to rear foot board, generally around the longitudinal axis.

5. The scooter of claim 3 comprising a torsion spring connecting the front foot board and the rear foot board.

6. The scooter of claim 5 wherein the torsion spring comprises a torsion bar.

7. The scooter of claim 5 wherein the torsion spring is formed integrally with the front foot board and the rear foot board.

8. The scooter of claim 1 wherein the front portion of the platform and the rear portion of the platform are not substantially twistable relative to each other generally around the longitudinal axis.

9. The scooter of claim 1 wherein the post is connected in a fixed position relative to the platform and the wheel is connected to the post in a fixed position relative to the post such that the wheel is not substantially rotatable relative to the longitudinal axis.

10. The scooter of claim 1 wherein the post has a post axis along its length and the post is rotatable generally around the post axis.

11. The scooter of claim 10 wherein the wheel is connected to the post such that the wheel changes direction relative to the longitudinal axis when the post is rotated around the post axis.

12. The scooter of claim 1 wherein the incline caster comprises more than one incline caster.

13. The scooter of claim 1 wherein the inclined caster comprises a caster axis around which the caster rotates and a caster wheel that rotates around a caster axle wherein the caster axle is generally orthogonal skew to the caster axis.

14. The scooter of claim 1 wherein the caster axis lies in a plane substantially parallel to a plane perpendicular to the ground that contains the longitudinal axis.

15. The scooter of claim 13 wherein the caster axis forms an acute angle with a vertical axis perpendicular to the ground.

16. The scooter of claim 13 wherein the caster axis forms an angle with a vertical axis perpendicular to the ground of about 25 degrees.

17. The scooter of claim 13 wherein the caster axis forms an angle with a vertical axis perpendicular to the ground of less than about 25 degrees.

18. The scooter of claim 5 wherein the inclined axis is connected to the torsion spring.

19. The scooter of claim 1 further comprising one or more wheels connected to the rear portion of the platform with connections other than inclined casters.

20. The scooter of claim 1 further comprising one or more wheels connected to the front portion of the platform but not connected to the post.

21. The scooter of claim 13 wherein the shortest distance between the caster axle and the caster axis is about 8 percent longer than the radius of the caster wheel.

22. The scooter of claim 13 wherein the shortest distance between the caster axle and the caster axis is at least about 8 percent longer than the radius of the caster wheel.

23. The scooter of claim 13 wherein the shortest distance between the caster axle and the caster axis is about 1.62 inches and the radius of the caster wheel is about 1.5 inches.

24. The scooter of claim 13 wherein, when the inclined caster is rotated such that the caster axle is at its minimum distance from the platform, the distance between caster axle and the axle of the front wheel is about 27 inches.

25. The scooter of claim 13 wherein, when the inclined caster is rotated such that the caster axle is at its minimum distance from the platform, the distance between caster axle and the axle of the front wheel is less than about 27 inches.

26. The scooter of claim 13 wherein the inclined caster includes one or more stops that restricts rotation of the inclined caster past one or more certain points.

27. The scooter of claim 13 wherein the inclined caster includes a biasing apparatus that urges the inclined caster to rotate to a designated position independent of gravitational forces.

28. A scooter comprising:
a platform having a front end, a rear end, a bottom, and a longitudinal axis parallel to the ground and extending through the front end and the rear end of the platform, the front end comprising a front foot portion and the rear end comprising a rear foot portion, wherein the rear foot portion is twistable around the longitudinal axis;
a post connected to the front end of the platform and extending generally upward from the front end of the platform;
a front wheel connected to the post such that at least a portion of the front wheel extends below the bottom of the platform; and
an inclined caster connected to the rear end of the platform with at least a portion of the wheel extending below the bottom of the platform, the inclined caster configured so that the scooter is capable of being propelled forward generally along the longitudinal axis by the application of a force to the rear foot portion, the force being applied substantially perpendicular to the longitudinal axis.

29. A scooter comprising:
a platform having a front end, a rear end, a bottom, and a longitudinal axis parallel to the ground and extending through the front end and the rear end of the platform, the front end comprising a front foot portion and the rear end comprising a rear foot portion, wherein the rear foot portion is twistable around the longitudinal axis;
a post connected to the front end of the platform and extending generally upward from the front portion of the platform;
a front wheel connected to the post such that at least a portion of the front wheel extends below the bottom of the platform; and
a wheel assembly, including
a wheel, connected to the rear end of the platform with at least a portion of the wheel extending below the bottom of the platform, the wheel being turnable relative to the longitudinal axis upon the application of a force to the rear foot portion, the force being applied substantially perpendicular to the longitudinal axis; and
a biasing device that resists the turning of the wheel upon the application of the force such that the scooter is capable of being propelled forward generally along the longitudinal axis by the application of the force.
